(19) United States
(12) Patent Application Publication
(10) Pub. No.: US 2023/0341288 A1
(43) Pub. Date: Oct. 26, 2023

(54) ELECTROCHEMICAL KILL SWITCH ASSEMBLY AND METHOD OF USE THEREOF

(71) Applicant: White Knight Controls, LLC, Edmona, OK (US)

(72) Inventor: Robert H. Wittman, Houston, TX (US)

(73) Assignee: White Knight Controls, LLC, Edmond, OK (US)

(21) Appl. No.: 18/306,127

(22) Filed: Apr. 24, 2023

Related U.S. Application Data
(60) Provisional application No. 63/333,598, filed on Apr. 22, 2022.

(51) Int. Cl. G01M 3/16; G08B 21/20; H02H 7/18

(52) U.S. Cl. CPC G01M 3/16; G08B 21/20; H02H 7/18; H02J 7/0031

(57) ABSTRACT

The invention relates to an electrochemical kill switch assembly having a conductive fluid detection circuit configured to activate when sensor electrodes are exposed to fluid at an oil and gas tank battery that contains a predetermined or threshold level of salt ions.

### CROSS-REFERENCE TO RELATED APPLICATIONS

This application claims the benefit of U.S. Provisional Patent Application No. 63/333,598 filed on Apr. 22, 2022, and incorporates said provisional application by reference in its entirety into this document as if fully set out at this point.

### BACKGROUND OF THE INVENTION

### 1. Field of the Invention

This invention generally relates to an electrochemical kill switch assembly and method of use thereof, and more particularly to an electrochemical kill switch assembly having a saline water detection circuit configured to activate when electrodes are exposed to water in an oil and gas tank battery that contains a predetermined or threshold level of salt ions.

### 2. Description of the Related Art

Saline water is a waste material that, if discharged in an uncontrolled manner, can be a serious and hazardous pollutant to the environment. The saline water commonly originates from wells producing oil and natural gas. The fluid produced from the wells is commonly pumped to a tank battery where the produced oil and natural gas fluids are separated from the saline water. The saline water separated from the oil and gas is typically stored temporarily in large holding tanks. The saline water is pumped from the holding tanks and typically injected at high pressure back into deep wells into the reservoir where it will not be an environmental hazard.

The tank battery is an enclosure surrounding the separation equipment, injection pumps, crude oil production storage tanks, saline water storage tanks, and hoses and piping. In the event of equipment or piping failure, the saline water can leak into the tank battery at a high rate, which is ultimately controlled by the flow rate of the producing wells that feed into the tank battery. The produced fluid can come from an individual well or multiple wells.

The wells and tank battery typically function without the presence of a human operator on a twenty-four (24) hour per day basis. The equipment and pumps in the tank battery typically have interlocking safety devices that can shut off the wells feeding the produced fluid to the tank battery. However, these safety devices are known to be prone to failure or not sensitive enough to prevent a large discharge of saline water from accumulating over many hours of operation. In such cases, the highly corrosive, saline water will accumulate in the tank battery and potentially damage electrical equipment inside the tank battery. And in extreme cases, the saline water can fill the battery and overtop the walls spilling out onto the surrounding land, killing grass and trees and polluting natural drainage waterways.

Mechanical float switches are electromechanical in operation, which require the physical movement of a floating body to activate an electrical circuit to shut off associated equipment and valves. While float switches are commonly installed in the tank battery at oil and gas wells, they actuate based on the level of a liquid in the tank regardless of if the liquid is saline water, crude oil, or freshwater (e.g., rainwater). It is generally undesirable to shut down oil and gas production because of a mere rainstorm or other freshwater spills, and as such, these float switches are not an ideal method for a kill switch in the tank battery at oil and gas wells. Moreover, float switches are subject to mechanical fouling in the harsh environments associated with oil and gas wells.

### BRIEF SUMMARY OF THE INVENTION

The invention relates to an electrochemical kill switch assembly and method of use thereof at a tank battery at an oil and natural gas production well site. The electrochemical kill switch assembly is configured to shut down the flow of highly conductive, saline water into a tank battery during an early stage of any equipment or piping failure.

Accordingly, it is an object of this invention to provide an electrochemical or saltwater production kill switch assembly. The kill switch assembly includes a saline water detection control circuit and a rugged, insulated, and durable enclosure. The control circuit includes sensor electrodes separated by a nonconductive fluid gap, a power supply electrically connected to one of the electrodes, and a relay switch electrically connected to the electrodes. The electrodes have a bare external surface exposed to atmospheric conditions. The relay switch is configured to be electrically connected to a field controller at an oil and natural gas tank battery enclosure. The relay of the control circuit is configured to close when the electrodes are in fluid contact with saline water containing a predetermined or threshold level of salt/chloride ions, such that the water is electrically conductive.

In general, in a first aspect, the invention relates to an electrochemical kill switch assembly having a conductive fluid detection control circuit housed within an enclosure assembly. The conductive fluid detection control circuit includes sensor electrodes separated by a nonconductive fluid gap, a power supply electrically connected to one of the sensor electrodes, and a relay switch electrically connected to the electrodes. The relay is configured to be electrically connected to a field controller control circuit at an oil and natural gas tank battery enclosure. The conductive fluid detection control circuit is configured to activate the relay switch when the sensor electrodes come into contact with a fluid having a predetermined or threshold salinity concentration.

In an embodiment, the enclosure assembly has a sensor head with the sensor electrodes mounted therein and an enclosure body attached to the sensor head. The enclosure body is configured to protect electrical lead connections between the conductive fluid detection control circuit and the field controller control circuit.

In an embodiment, the enclosure assembly further includes a protective electrode shroud attached to the sensor head and configured to protect the sensor electrodes and a field controller connector head configured to connect the enclosure assembly to the field controller control circuit.

In an embodiment, the sensor head is connected to a first terminal end of the enclosure body, and the field controller connector head is connected to a second terminal end of the enclosure body.

In an embodiment, the sensor head further includes an adaptor fitting having an externally threaded end and an annular collared end, and an electrode holder assembly connected to the adaptor fitting. The externally threaded end of the adaptor fitting is removably attachable to the protective electrode shroud, and the annular collared end is removably attachable to the enclosure body. The electrode holder assembly has electrode receptacles for receipt of the sensor electrodes.

In an embodiment, the electrode holder assembly has an annular sealing groove configured for the receipt of a first sealing material for a sealed connection with the adaptor fitting, and each of the electrode receptacles has a sealing groove for the receipt of a second sealing material. The first sealing material, the second sealing material, or both can be fiberglass resin, epoxy resin, or a combination or mixture thereof.

In an embodiment, the enclosure assembly is as a polymer, a metal, or fiberglass. The polymer can be polycarbonate (PC), polyethylene (PE), polypropylene (PP), polyvinylchloride (PVC), or a combination thereof. The metal can be carbon steel, stainless steel, aluminum, or a combination or mixture thereof.

In an embodiment, the electrodes have a bare external surface exposed to atmospheric conditions. The electrodes can be constructed from a metal, a metal alloy, or other electrically conductive material, such as an oxide, polymeric, ceramic, mineral, carbon, silicon, graphite, a mixed metal oxide, hydroxyapatite, nichrome, graphite, or a mixture or combination thereof.

In an embodiment, the salinity concentration is about 1,000 ppm or greater, about 2,640 ppm or greater, or about 10,000 ppm or greater.

In an embodiment, an alarm circuit is in electrical communication with the saline water detection control circuit.

In general, in a second aspect, the invention relates to an electrochemical kill switch assembly having a conductive fluid detection control circuit. The conductive fluid detection control circuit has sensor electrodes separated by a nonconductive fluid gap, the sensor electrodes having a bare external surface exposed to atmospheric conditions. The control circuit also has a power supply electrically connected to one of the sensor electrodes and a relay switch electrically connected to the electrodes. The relay is configured to be electrically connected to a field controller control circuit at an oil and natural gas tank battery enclosure, and the conductive fluid detection control circuit is configured to activate the relay switch when the sensor electrodes come into contact with a fluid having a salinity concentration of about 1,000 ppm or greater. The kill switch assembly also includes an enclosure assembly housing the conductive fluid detection control circuit. The enclosure assembly has a sensor head having the sensor electrodes mounted therein, an enclosure body attached to the sensor head, the enclosure body configured to protect electrical lead connections between the conductive fluid detection control circuit and the field controller control circuit, a protective electrode shroud attached to the sensor head and configured to protect the sensor electrodes, and a field controller connector head configured to connect the enclosure assembly to the field controller control circuit.

In an embodiment, the sensor head has an adaptor fitting with an externally threaded end and an annular collared end. The externally threaded end of the adaptor fitting is removably attachable to the protective electrode shroud, and the annular collared end is removably attachable to the enclosure body. An electrode holder assembly is connected to the adaptor fitting, and the electrode holder assembly has electrode receptacles for receipt of the sensor electrodes. The electrode holder assembly can have an annular sealing groove configured for receipt of a first sealing material for a sealed connection with the adaptor fitting. Each of the electrode receptacles has a sealing groove for receipt of a second sealing material. The first sealing material, the second sealing material, or both can be fiberglass resin, epoxy resin, or a combination or mixture thereof.

In an embodiment, the enclosure assembly is as a polymer, a metal, or fiberglass. The polymer can be polycarbonate (PC), polyethylene (PE), polypropylene (PP), polyvinylchloride (PVC), or a combination thereof. The metal can be carbon steel, stainless steel, aluminum, or a combination or mixture thereof.

In an embodiment, the electrodes have a bare external surface exposed to atmospheric conditions. The electrodes can be constructed from a metal, a metal alloy, or other electrically conductive material, such as an oxide, polymeric, ceramic, mineral, carbon, silicon, graphite, a mixed metal oxide, hydroxyapatite, nichrome, graphite, or a mixture or combination thereof.

In an embodiment, the salinity concentration is about 2,640 ppm or greater or about 10,000 ppm or greater.

In an embodiment, an alarm circuit is in electrical communication with the saline water detection control circuit.

In general, in a third aspect, the invention relates to a method of detecting and stopping a flow of saline water using the electrochemical kill switch assembly disclosed herein. The method includes detecting when the sensor electrodes come into contact with water at an oil and natural gas gas tank battery enclosure having a predetermined or threshold salinity concentration. In response to the switch assembly detecting the saline water, the method triggers the kill switch assembly to stop a flow of the water, stop equipment, or a combination of both at the oil and natural gas tank battery enclosure.

In an embodiment, the method also includes the step of installing the electrochemical kill switch assembly at the oil and natural gas tank battery enclosure.

In an embodiment, the method also includes the step of monitoring the electrochemical kill switch assembly at the oil and natural gas tank battery enclosure.

In an embodiment, the method also includes the step of electronically activating an alarm circuit.

### BRIEF DESCRIPTION OF THE DRAWINGS

The above and other objects and advantages of this invention may be more clearly seen when viewed in conjunction with the accompanying drawing wherein:

FIG. 1 is an elevation view of an example of a saltwater production kill switch assembly in accordance with an illustrative embodiment of the invention disclosed herein.

FIG. 2 is an exploded elevation view of the kill switch assembly shown in area 2 of FIG. 2.

FIG. 3 is a cross-sectional view along line 3-3 of the kill switch assembly shown in FIG. 2.

FIG. 4 is a partially exploded, cross-sectional view of an example of an electrode holder assembly in accordance with an illustrative embodiment of the kill switch assembly disclosed herein.

FIG. 5 is a plan view of the electrode holder assembly shown in FIG. 4.

FIG. 6 is a cross-sectional view along line 6-6 of FIG. 5.

FIG. 7 is an electrical schematic of an example of a conductive fluid detection control circuit in accordance with an illustrative embodiment of the invention disclosed herein.

### DETAILED DESCRIPTION OF THE INVENTION

While this invention is susceptible of embodiment in different forms, there is shown in the drawings, and will herein be described hereinafter in detail, some specific embodiments of the invention. It should be understood, however, that the present disclosure is to be considered an exemplification of the principles of the invention and is not intended to limit the invention to the specific embodiments so described.

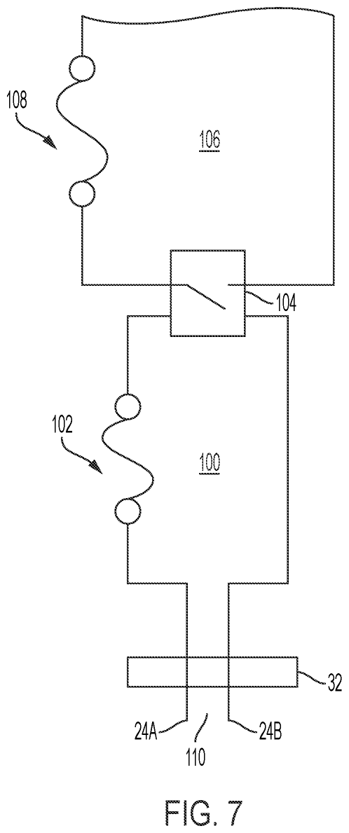

The invention relates to an electrochemical kill switch assembly and a method of use thereof. The electrochemical kill switch assembly 10 includes a saline water detection control circuit 100 (FIG. 7) that activates when the switch assembly 10 comes into fluid contact with electrically conductive water, such as from an oil and natural gas production well. The electrochemical kill switch assembly 10 is configured to be positioned at a low point within the confines of a tank battery at an oil and natural gas production well site. The kill switch assembly 10 is electrically connected to an existing field controller and a field controller power source (e.g., a 480-volt, three-phase power source) at the well site.

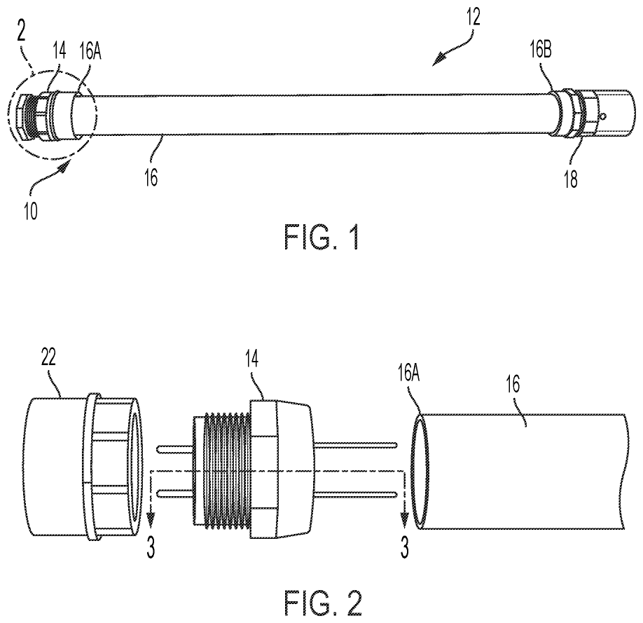

The kill switch assembly 10 is housed within an enclosure assembly 12 that is rugged, insulated, and durable. The enclosure assembly 12 is constructed from any suitable nonconductive material having sufficient structural integrity and rigidity, such as a polymer (e.g., polycarbonate (PC), polyethylene (PE), polypropylene (PP), polyvinylchloride (PVC)), a metal (e.g., carbon steel, stainless steel, aluminum), or fiberglass. As exemplified in FIGS. 1 and 2, the enclosure assembly 12 includes a sensor head 14 connected to a first terminal end 16A of an enclosure body 16 and a field controller connector head 18 connected to a second terminal end 16B of the enclosure body 16. A protective electrode shroud 22 is connected to the sensor head 14 and is configured to protect a pair of sensor electrodes 24A/24B that are physically mounted within the sensor head 14. The field controller connector head 18 is configured to connect the kill switch assembly 10 to the field controller at the tank battery at an oil and natural gas production well site. The enclosure body 16 is configured to protect electrical lead connections between the sensor head 14 and the field controller.

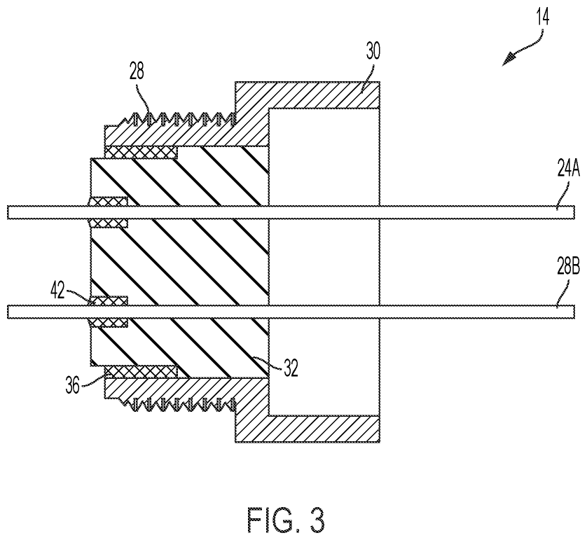

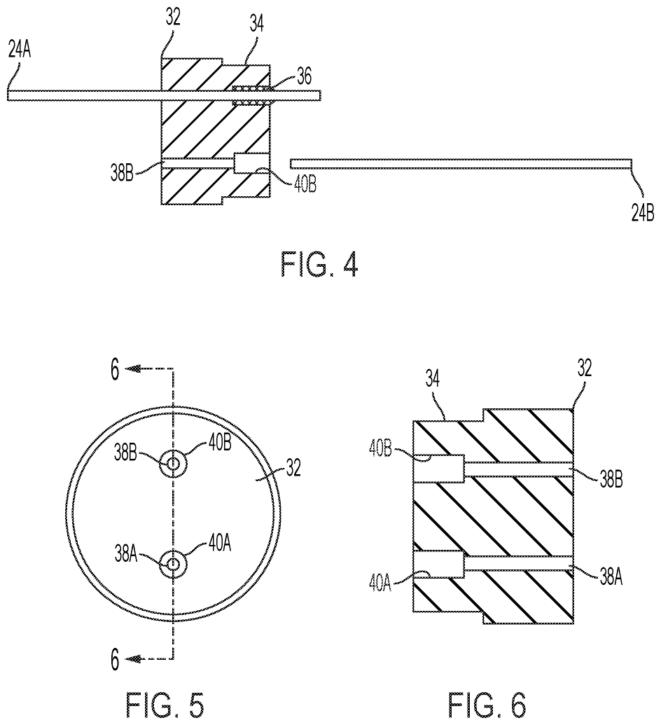

As illustrated in FIGS. 3 through 6, the sensor head 14 includes an adaptor fitting 26 having an externally threaded end 28 and an annular collared end 30. The externally threaded end 28 is removably attachable to the protective electrode shroud 22, and the annular collared end 30 is removably attachable to the enclosure body 16 of the enclosure assembly 12. An electrode holder assembly 32 is mounted within the adaptor fitting 26. The electrode holder assembly 32 includes an annular sealing groove 34 for receipt of a suitable insulating and sealing material (e.g., epoxy or fiberglass resin) 36 for a sealed connection with the adaptor fitting 26. In addition, the electrode holder assembly 32 includes electrode receptacles 38A/38B for receipt of the sensor electrodes 24A/24B. Each of the electrode receptacles 38A/38B can include a sealing groove 40A/40B for receipt of a suitable insulating and sealing material (e.g., epoxy or fiberglass resin) 42, and the sensor electrodes 24A/24B are physically mounted within the electrode holder assembly 32 of the sensor head 14.

The sensor electrodes 24A/24B of the kill switch assembly 10 have a bare external surface exposed to atmospheric conditions. The sensor electrodes 24A/24B can be constructed of any suitable metal, metal alloy, or other electrically conductive material, such as an oxide, polymeric, ceramic, mineral, carbon, silicon, graphite, a mixed metal oxide, hydroxyapatite, nichrome, or graphite.

Turning now to FIG. 7, the saline water detection control circuit 100 of the kill switch assembly 10 includes the sensor electrodes 24A/24B, a kill switch assembly power supply 102 electrically connected to one of the sensor electrodes 24A or 24B, and a relay 104 electrically connected to a field control circuit 106. The kill switch assembly power supply 102 can be a separate electrical component or can be electrically connected to a field controller power source 108. The kill switch assembly power supply 102 can be low voltage (e.g., a 12- to 24-volts, 3- to 10-amp power supply); however, the invention is not so limited as the electromechanical kill switch assembly 10 can operate with any suitable voltage, including voltage supplied directly from the field controller power source 108.

In normal operating conditions, the sensor electrodes 24A/24B are separated by a gap 110 of air or other inert and nonconductive fluid with the relay 104 of the saline water detection circuit 100 in an unactivated state. Due to the nonconductive gap 110 between the two sensor electrodes 24A/24B, no electrical circuit is formed between the electrode 24A or 24B to which the power supply 102 is connected and the other electrode 24A or 24B. When the electrodes 24A/24B are contacted with a conductive liquid containing a predetermined or threshold level of salt/chloride ions, the control circuit 100 goes into an activated state, allowing current to flow from the power supply 102, through the electrode 24A or 24B to which the power supply 102 is connected, across the gap 110, and onto the other electrode 24A or 24B and from there into the relay 104. In this activated state, the control circuit 100 is closed with a full electrical loop from the power supply 102 to the other electrode 24A or 24B to the relay 104 and back to the power supply 102.

In the activated states, the saline water detection circuit 100 triggers the electrochemical kill switch assembly 10 to shut down equipment in the tank battery. The relay 104 closure stops the flow of saline water from wells and water pumps such that the tank battery can contain the saline water spill before impacting the surrounding environment. The control circuit 100 can also electronically activate an alarm circuit that will notify response personnel (e.g., a field pumper or operator) of the location and status of the incident.

The electrochemical kill switch assembly 10 can be activated by electrically conductive fluid having a predetermined concentration or threshold level of salt. The salt concentration requirements can depend upon the location of the oil and gas well site and can be set and adjusted by the operator or leaseholder. For example, some environmental regulations allow for up to 1,000 ppm of salt in water and up to 2,640 ppm of salt in the soil, and as such, the salt concentration could be preset to greater than the particular controlling environmental regulations. The control circuit 100 would remain active until the electrodes 24A/24B were submerged in a fluid with a salinity lower than the triggering concentration (e.g., about 3,000 ppm).

The kill switch assembly and method of use thereof described herein can further comprise one or more modules with an Ethernet-based control system, such as SCADA configured to shut down a module or a component within a module if personnel or the environment are at risk, including but not limited to, exposure to toxic fumes, out of control chemical reactions, computer or component malfunctions in the module.

The description of the invention is intended to be read in connection with the accompanying drawings, which are to be considered part of the entire written description of this invention. In the description, relative terms such as “front,” “rear,” “lower,” “upper,” “horizontal,” “vertical,” “inward,” “outward,” “up,” “down,” “top” and “bottom”, as well as derivatives thereof (e.g., “horizontally,” “downwardly,” “upwardly” etc.), should be construed to refer to the orientation as then described or as shown in the drawings under discussion. These relative terms are for convenience of description and do not require that the device be constructed or the method to be operated in a particular orientation. Terms, such as “connected,” “connecting,” “attached,” “attaching,” “join” and “joining” are used interchangeably and refer to one structure or surface being secured to another structure or surface or integrally fabricated in one piece.

For purposes of the instant disclosure, the term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. Terms of approximation (e.g., “about”, “substantially”, “approximately”, etc.) should be interpreted according to their ordinary and customary meanings as used in the associated art unless indicated otherwise. Absent a specific definition and absent ordinary and customary usage in the associated art, such terms should be interpreted to be ±10% of the base value.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

Thus, the invention is well adapted to carry out the objects and attain the ends and advantages mentioned above as well as those inherent therein. While the inventive concept has been described and illustrated herein by reference to certain illustrative embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. An electrochemical kill switch assembly, comprising:
a conductive fluid detection control circuit housed within an enclosure assembly, said conductive fluid detection control circuit comprising:
sensor electrodes separated by a nonconductive fluid gap;
a power supply electrically connected to one of the sensor electrodes; and
a relay switch electrically connected to the electrodes, the relay configured to be electrically connected to a field controller control circuit at an oil and natural gas tank battery enclosure;
wherein the conductive fluid detection control circuit is configured to activate the relay switch when the sensor electrodes come into contact with a fluid having a predetermined or threshold salinity concentration.

2. The kill switch assembly of claim 1 wherein the enclosure assembly comprises:
a sensor head having the sensor electrodes mounted therein; and
an enclosure body attached to the sensor head, the enclosure body configured to protect electrical lead connections between the conductive fluid detection control circuit and the field controller control circuit.

3. The kill switch assembly of claim 2 wherein the enclosure assembly further comprises:
a protective electrode shroud attached to the sensor head and configured to protect the sensor electrodes; and
a field controller connector head configured to connect the enclosure assembly to the field controller control circuit.

4. The kill switch assembly of claim 3 wherein the sensor head is connected to a first terminal end of the enclosure body and the field controller connector head is connected to a second terminal end of the enclosure body.

5. The kill switch assembly of claim 3 wherein the sensor head further comprises:
an adaptor fitting comprising an externally threaded end and an annular collared end, the externally threaded end of the adaptor fitting removably attachable to the protective electrode shroud, the annular collared end removably attachable to the enclosure body;
an electrode holder assembly connected to the adaptor fitting, the electrode holder assembly comprising electrode receptacles for receipt of the sensor electrodes.

6. The kill switch assembly of claim 5 wherein the electrode holder assembly further comprises:
an annular sealing groove configured for receipt of a first sealing material for a sealed connection with the adaptor fitting; and
each of the electrode receptacles comprising a sealing groove for receipt of a second sealing material.

7. The kill switch assembly of claim 6 wherein the first sealing material, the second sealing material, or both is a fiberglass resin, an epoxy resin, or a combination or mixture thereof.

8. The kill switch assembly of claim 1 wherein the enclosure assembly is as a polymer, a metal, or fiberglass.

9. The assembly of claim 8 wherein said polymer is polycarbonate (PC), polyethylene (PE), polypropylene (PP), polyvinylchloride (PVC), or a combination thereof.

10. The assembly of claim 8 wherein said metal is carbon steel, stainless steel, aluminum, or a combination or mixture thereof.

11. The assembly of claim 1 wherein said electrodes have a bare external surface exposed to atmospheric conditions.

12. The assembly of claim 11 wherein said electrodes are constructed from oxide, polymeric, ceramic, mineral, carbon, silicon, graphite, a mixed metal oxide, hydroxyapatite, nichrome, or graphite, or a mixture or combination thereof.

13. The assembly of claim 11 wherein the salinity concentration is about 1,000 ppm or greater.

14. The assembly of claim 13 wherein the salinity concentration is about 2,640 ppm or greater.

15. The assembly of claim 14 wherein the salinity concentration is about 10,000 ppm or greater.

16. The assembly of claim 1 further comprises an alarm circuit in electrical communication with the saline water detection control circuit.

17. An electrochemical kill switch assembly, comprising:
a conductive fluid detection control circuit, said conductive fluid detection control circuit comprising:
sensor electrodes separated by a nonconductive fluid gap, the sensor electrodes having a bare external surface exposed to atmospheric conditions;
a power supply electrically connected to one of the sensor electrodes; and
a relay switch electrically connected to the electrodes, the relay configured to be electrically connected to a field controller control circuit at an oil and natural gas tank battery enclosure;
wherein the conductive fluid detection control circuit is configured to activate the relay switch when the sensor electrodes come into contact with a fluid having a salinity concentration of about 1,000 ppm or greater;
an enclosure assembly housing the conductive fluid detection control circuit, the enclosure assembly comprising:
a sensor head having the sensor electrodes mounted therein;
an enclosure body attached to the sensor head, the enclosure body configured to protect electrical lead connections between the conductive fluid detection control circuit and the field controller control circuit;
a protective electrode shroud attached to the sensor head and configured to protect the sensor electrodes; and
a field controller connector head configured to connect the enclosure assembly to the field controller control circuit.

18. The kill switch assembly of claim 17 wherein the sensor head further comprises:
an adaptor fitting comprising an externally threaded end and an annular collared end, the externally threaded end of the adaptor fitting removably attachable to the protective electrode shroud, the annular collared end removably attachable to the enclosure body;
an electrode holder assembly connected to the adaptor fitting, the electrode holder assembly comprising electrode receptacles for receipt of the sensor electrodes; the electrode holder assembly further comprising an annular sealing groove configured for receipt of a first sealing material for a sealed connection with the adaptor fitting; and each of the electrode receptacles comprising a sealing groove for receipt of a second sealing material.

19. The kill switch assembly of claim 18 wherein the first sealing material, the second sealing material, or both is a fiberglass resin, an epoxy resin, or a combination or mixture thereof.

20. The kill switch assembly of claim 17 wherein the enclosure assembly is as a polymer, a metal, or fiberglass.

21. The assembly of claim 20 wherein said polymer is polycarbonate (PC), polyethylene (PE), polypropylene (PP), polyvinylchloride (PVC), or a combination thereof.

22. The assembly of claim 20 wherein said metal is carbon steel, stainless steel, aluminum, or a combination or mixture thereof.

23. The assembly of claim 17 wherein said electrodes are constructed from a metal, a metal alloy, or other electrically conductive material, such as an oxide, polymeric, ceramic, mineral, carbon, silicon, graphite, a mixed metal oxide, hydroxyapatite, nichrome or graphite.

24. The assembly of claim 17 wherein the salinity concentration is about 2,640 ppm or greater.

25. The assembly of claim 1 wherein the salinity concentration is about 10,000 ppm or greater.

26. The assembly of claim 17 further comprising an alarm circuit in electrical communication with the saline water detection control circuit.

27. A method of detecting and stopping a flow of saline water using the electrochemical kill switch assembly of claim 1, the method comprising the steps of:
a. detecting when the sensor electrodes come into contact with water at an oil and natural gas gas tank battery enclosure having a predetermined or threshold salinity concentration; and
b. in response, triggering the kill switch assembly to stop a flow of the water, stop equipment, or a combination of both at the oil and natural gas tank battery enclosure.

28. The method of claim 27 further comprises the step of installing the electrochemical kill switch assembly at the oil and natural gas tank battery enclosure.

29. The method of claim 27 further comprises the step of monitoring the electrochemical kill switch assembly at the oil and natural gas tank battery enclosure.

30. The method of claim 27 further comprises the step of electronically activating an alarm circuit in response detecting when the sensor electrodes come into contact with the water.
